(19) United States
(12) Patent Application Publication
(10) Pub. No.: US 2013/0191212 A1
(43) Pub. Date: Jul. 25, 2013

(54) Tools and Methods for Managing Consumer Behavioral Information

(71) Applicants: Michael David Shepherd, Ontario, NY (US); Dale Ellen Gaucas, Penfield, NY (US); Kirk J. Ocke, Ontario, NY (US)

(72) Inventors: Michael David Shepherd, Ontario, NY (US); Dale Ellen Gaucas, Penfield, NY (US); Kirk J. Ocke, Ontario, NY (US)

(73) Assignee: XEROX CORPORATION, Norwalk, CT (US)

(21) Appl. No.: 13/357,464

(22) Filed: Jan. 24, 2012

(51) Int. Cl. G06Q 30/02

(52) U.S. Cl. 705/14.53

(57) ABSTRACT

Apparatus are provided that includes a data communications device configured to communicate one or more offers regarding a product or service to one or more target recipients. A data segmentation engine is configured to communicate with the data communication device and to process data regarding the target recipients interaction with the one or more offers. The data segmentation engine is configured to tag the target recipients with data associated with the offer and with data regarding the target recipients interaction with the offer. A graphing engine is configured to create one or more semantic representations of behavior of the one or more target recipients, and the resulting semantic representations can include information tagged to each target recipient by the data segmentation engine. The semantic representations are used to determine which set of target recipients will be communicated with subsequent semantically-related offers.

### FIELD OF THE DISCLOSURE

Aspects of the present disclosure relate to tools and methods for gathering, managing, and/or organizing behavioral information regarding the recipients of an offer.

### BACKGROUND

Marketing that is targeted to specific groups of consumers is becoming more and more important as companies vie for consumer dollars. Various techniques are employed to try to ensure that the consumers that are receiving marketing information or incentive offers are more likely to respond to those communications, whether it results in a subsequent transaction or the communication being forwarded to other consumers. For example, some current forms of market targeting are employed through geographic location, demographics, or psychographics. While these techniques can produce some increase in the effectiveness of a marketing campaign, these techniques ignore any purchasing habits or information-sharing, for example, through social media outlets, to achieve better marketing results.

### SUMMARY

In accordance with one aspect of the present disclosure, apparatus are provided that include a data communications device configured to communicate one or more offers regarding a product or service to one or more target recipients. The target recipients can view the offer on a display on a target recipient data communications device. A data segmentation engine is configured to communicate with the data communication device and to process data regarding the target recipients' interaction with the one or more offers. The data segmentation engine is configured to tag the target recipients with data associated with the offer and with data regarding the target recipients' interaction with the offer. A graphing engine is configured to create one or more semantic representations, for example, graphs, of behavior of the one or more target recipients, and the semantic representations can include information tagged to each target recipient by the data segmentation engine. The graphing engine can be configured to present the one or more semantic representations on a display on the data communication device.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of one embodiment of a communication system for managing and gathering data regarding one or more target recipients interaction with one or more offers;

FIG. 2 is a schematic diagram of various data types of the communications system of FIG. 1;

FIG. 3 is a flowchart of a process for gathering data regarding target recipients of an offer and segmenting the gathered data;

FIG. 4 is a functional schematic diagram of all or a portion of a screen or a window of a designated target recipient data communications device in one embodiment of the disclosure; and

FIG. 5 is one embodiment of a graph created using data and gathered and segmented regarding target recipients of an offer.

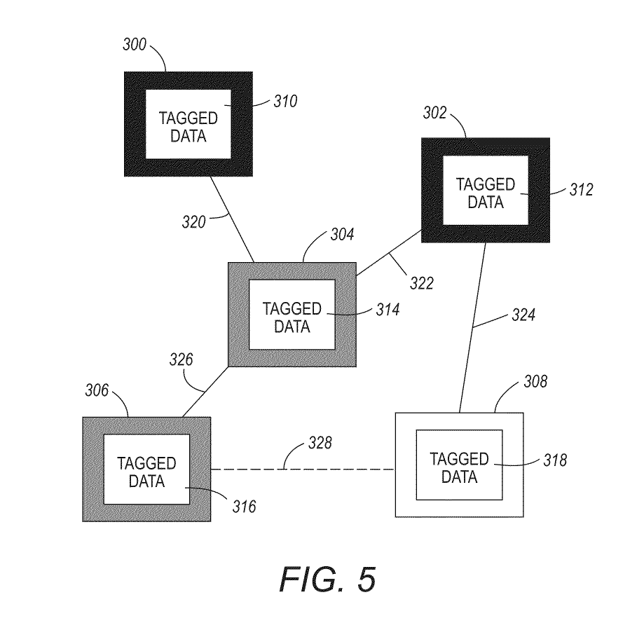

### DETAILED DESCRIPTION

Aspects of the disclosure are directed to a communication system that includes a various components configured to gather and segment information regarding the interaction between a target recipients and an offer communicated thereto. Information is gathered, including information regarding the behavior of the target recipient after receiving an offer, and information regarding the contents of the offer itself. This information is used to create information, for example, visual representations, of a target recipients' responses to an offer to allow subsequent semantically-related offers to be targeted to updated groups of target recipients to improve upon the desired results in the subsequent offer. An offer can be any information, communicated to one or more recipients that can include any of an offer, campaign, coupon, incentives, or other communication regarding any product and/or service offered to the recipients. A target recipient can be any individual, business, corporation, or other entity to which an offer can be communicated.

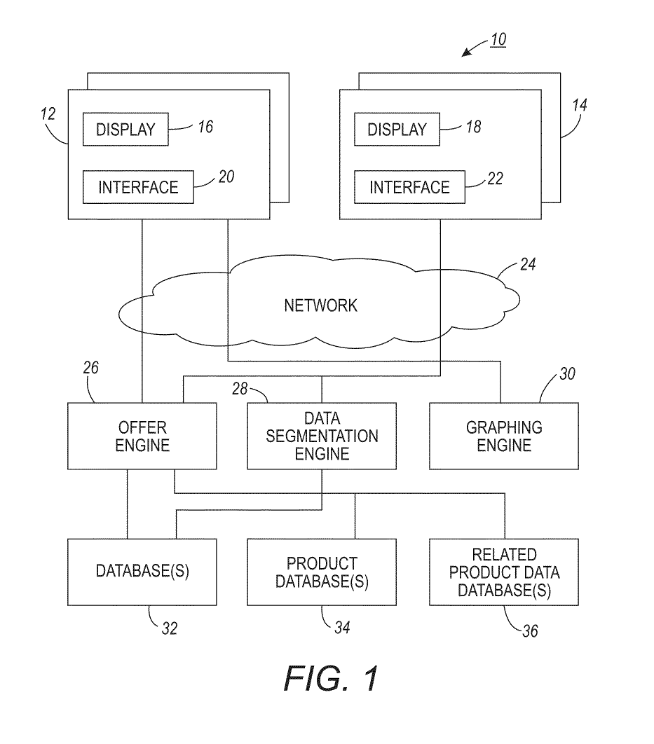

Referring now to the drawings in greater detail, FIG. 1 shows a block diagram of a communication system 10 that includes a data communication network 24 that is in communication with one or more data communication devices 12 configured to transmit and/or receive a variety of types of data and/or messages, including one or more offers, to and from other devices via the data communication network 24. One or more target recipient data communication devices 14 are also provided that are configured to transmit and/or receive various types of data and messages, including offers for products and/or services or incentive offers from the data communication devices 12. The data communication devices 12 and the target recipient data communication devices 14 can include an interface 20, 22, such as a network interface or other type of interface, to allow the devices 12, 14 to communicate with other components and/or devices through the communications system 10.

The communications system 10 also includes various components for gathering, segmenting, and graphing information and data received regarding the target recipients and their behavior in regards to the offers. In one embodiment, the communication system 10 includes an offer engine 26, a data segmentation engine 28, a graphing engine 30, and one or more data repositories, including a product database 34, a related product data database 36, and various other databases 32 for storing data. The various engines can be in the form of configuration tools to allow the communications system 10 to aggregate and configure sets of assets or data, including data regarding the target recipients and the behavior of the target recipients to response to the offers sent by the data communication devices 12.

The various engines are provided to manage the interactions within the communications system 10. In one embodiment, the one or more offer engines 26 are provided, and they are configured to manage the setup and/or management of offers communicated to the target recipients. In the process of setting up and/or managing one or more offers, the offer engine 26 can produce and/or modify data regarding the offer, and that data is stored in one or more databases 32 located in the communications system 10.

The offer created by the offer engine 26 can be communicated to a set of target recipients in a variety of ways. In one embodiment, the offer can be communicated using a social networking tool. In this way, the communication system 10 can track the interaction of the target recipients with the offer, and also the relationships and interactions between the target recipients, as will be discussed in more detail below.

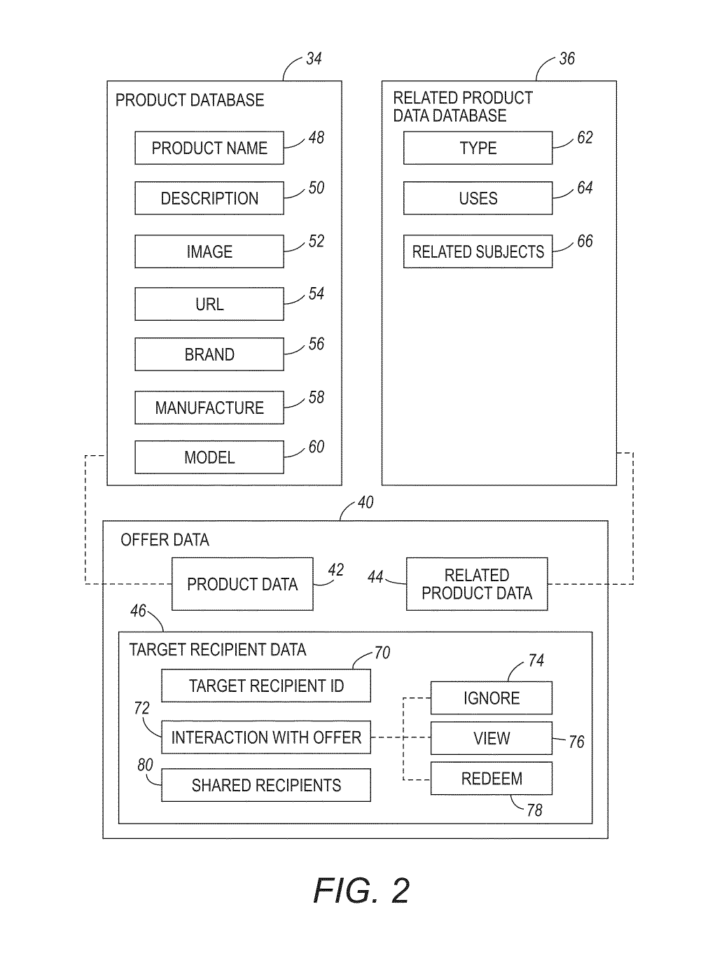

The one or more data segmentation engines 28 are configured to manage the segmentation of data and information received regarding the target recipients and the behavior of the target recipients to response to the offers. For example, the data segmentation engine 28 is configured to segment data regarding the type of behavior recorded for each target recipient in response to the offer, including a target recipient viewing the offer, ignoring the offer, redeeming the offer, and/or sharing the offer with additional target recipients. The data segmentation engine 28 can also segment data regarding the types of offers that elicit a certain response from the target recipients in order to associate, or tag, each target recipient with the information regarding those types of offers. This information can be used during the communication of subsequent semantically-related offers to deliver those offers to those target recipients most likely to behave with regards to the subsequent offer in a desired manner. One exemplary embodiment of the type of data gathered regarding the target recipients and the behavior of the target recipients in response to the offers is shown in FIG. 2, which will be discussed in more detail below.

The graphing engine 30 is configured to create one or more visual representations of the data collected and managed by the data segmentation engine 28. In one embodiment, one or semantic graphs can be created by the graphing engine 30, such that the graphing engine 30 creates a visual representation of the behavior of the target recipients to a given offer, including information about their behavior and information about the offers that elicit certain types of behavior. The graphing engine is configured to communicate with the data communication device 12 such that the graphs are displayed on the display 16 on the data communication devices 12. The information represented in the graphs created by the graphing engine 30 can be used to update the target recipient list such that a subsequent semantically-related offer is communicated to the updated target recipients list.

As explained above, various databases can be used to store information regarding the offers, the target recipients, and the behavior of the target recipients in response to the offers communicated thereto, including the product database 34 and the related product data database 36. The product database 34 can contain a variety of information about a plurality of products and/or services that can be included in or referred to in an offer. Various sources of information can be used for retrieving semantic information about the product or service representing the offer. For example, there are various product ontologies or knowledge bases that contain information about a plurality of products and services that can be accessed by the offer engine 26 to include with the offer. These repositories of information can be used to access information about the content of the offer and be passed along with the offer. This information can be used to tag one or more target recipients with additional information about their interaction with a given offer to determine which subsequent offers should be communicated thereto. For example, when a target recipient interacts with a given offer in a desired manner, that target recipient can be tagged with information about the contents of the given offer to allow subsequent offers containing similar or the same content to be directed to that target recipient. In addition, this information is also used in the creation of semantic graphs of the target recipients and their response to a given offer, as will be discussed in the more detail below.

The related product data database 36 can contain a variety of information relating to a plurality of products and/or services that can be included in or referred to in an offer. Related product data can include any data or information that relates to product or service, and can include, for example, various categories that the product or service related to or any related subjects or other products or services. Various sources of information can be used for retrieving information relating to the product or service representing the offer. For example, there are various product ontologies or knowledge bases that contain information that relates to various products and services that can be accessed by the offer engine 26 to include with the offer. These repositories of information can be used to access information that is related to the content of the offer and be passed along with the offer. Similar to the product information, this information can be used to tag one or more target recipients with additional information about their interaction with a given offer to determine which subsequent offers should be communicated thereto. For example, a target recipient can be tagged with information about a category of the products or services that elicits a desired interaction with the offer to be used in targeting subsequent offers to a set of target recipients.

The offer data that is transmitted and/or modified as the offer is communicated to the target recipients can include various types of data and information about the offer and the target recipients associated with the offer. In one embodiment, shown in FIG. 2, the offer data 40 includes product data 42, related product data 44, and target recipient data 46. It will be appreciated, however, that the offer data can include any semantic information regarding each offer associated with the communications system 10 regarding information about the offer, the contents of the offer, and the one or more target recipients that receive the communicated offer.

The product data 42 can include information accessed from the product database 34, and can include, for example, a product name 48, product description 50, a product image 52, a product URL 54 that can link to a webpage with additional information about the product, a brand 56 of the product, a manufacturer 58 of the product, and a model 60 or model number of the product. It will be appreciated that any information concerning the product can be included in the product data 42.

The related product data can include information accessed from the related product data database 36, and can include, for example, a type 62 of product or service, a use 64 or uses of the product or service, and related subjects 66 to the product or service.

The target recipient data 46 contains information about the each target recipient associated with the offer. The target recipient data 46 includes a target recipient identification data 70, which is data used to identify each individual target recipient. For example, the types of identification information that can be used can include name, email address, and/or a username on a social networking tool through which the offer was communicated. It will be appreciated that each target recipient can be identified with any information as long as each target recipient has a unique identification. The target recipient data 46 can also include interaction with the offer data 72, which is data for identifying the interaction or behavior of the target recipient with the offer. The interaction with the offer data 72 can include the target recipient ignoring the offer 74, viewing the offer 76, or redeeming the offer 78. The target recipient data 46 also include shared recipient data 80, which includes data regarding additional target recipients that received the offer from other target recipients. The shared recipient data 80 can include information about the recipient that received the offer, and the relationship between the two recipients.

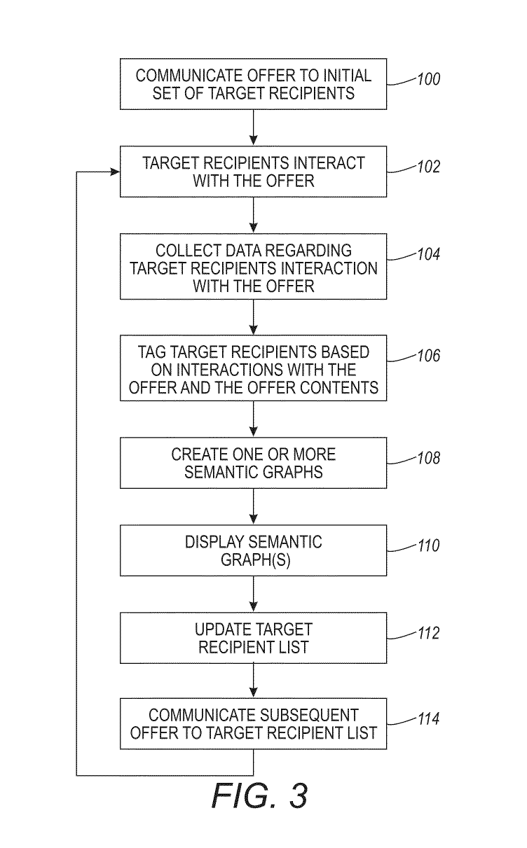

FIG. 3 shows a flowchart of processes that allows an offer to be created and/or managed and communicated to one or more target recipients by the communication system 10, and for data to be gathered and segmented regarding the behavior of the target recipients with respect to the offer. The illustrated processes are carried out, in the illustrated embodiment, by the communications system 10 shown in FIG. 1. In act 100, an offer is communicated to an initial set of target recipients. The offer is created and communicated to the target recipients by the offer engine 26 and displayed to the target recipients using the display 18 of the one or more target data communication devices.

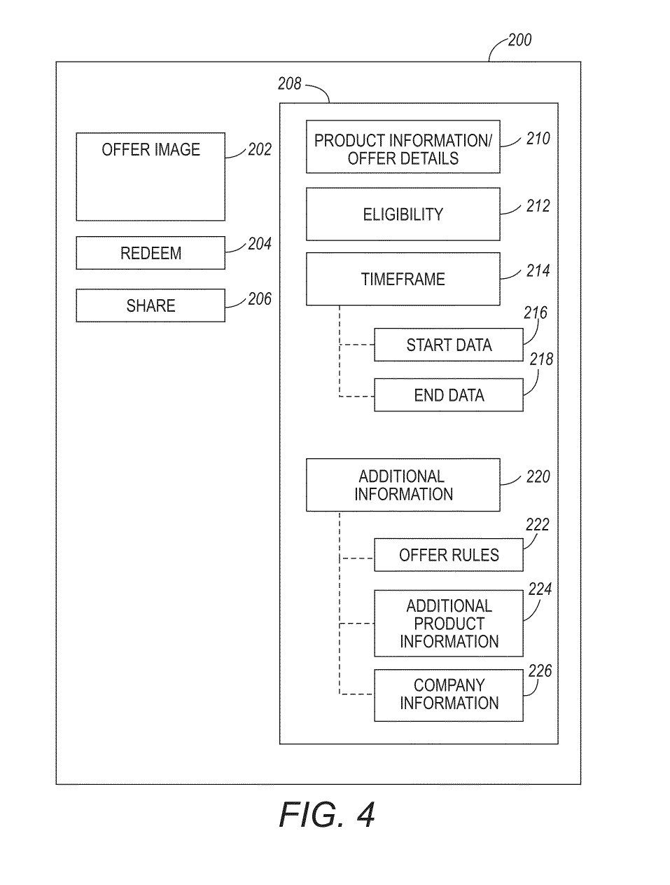

An offer interface can be presented to the target recipients on the target recipient data communications devices 14. A graphical user interface element may be displayed to the target recipients on the device 14 that is configured to display the offer interface to allow the target recipient to view and interact with the offer. In one embodiment shown in FIG. 4, the offer interface 200 can include an offer image 202 that can display to the target recipient an image of the product or service, or any other visual associated with the contents of the offer. The offer interface 200 also includes functionality to allow the target recipient to interact with offer. For example, the offer interface 200 can include a redeem tool 204 that allows the target recipient to redeem the offer, and a share tool 206 that allows the target recipient to share the offer with another target recipient. In one embodiment, the target recipient can share the offer with another user in their social network when the offer is received by the target recipient using a social networking tool. The offer interface 200 presented to the target recipient when they choose to view the offer also include offer details data 208, which is any data provided with the offer that provides additional information about the offer. For example, the offer details data 208 can include product and/or service information 210 that includes information about the product or service associated with the offer. The offer details data 208 also includes eligibility data 212 that provides the target recipient with information about the requirements for eligibility to redeem the offer. Timeframe data 214 provides the target recipients with information about a timeframe for redeeming and/or sharing the offer, and can include start time data 216 and end time data 218, each of which can include a date and/or time. The additional information data 220 includes any additional information that can provided with the offer, and can include offer rules data 222, additional production information 224, and/or company information 226 that provides information about the entity communicating the offer to the target recipients. It will be appreciated that the information included in the offer details data 208 can be any combination of the data described above or any other information that may be provided regarding the offer.

In act 102, the target recipients can interact with the offer. For example, the target recipients can ignore the offer, view the offer, redeem the offer, and/or share the offer with additional target recipients. In act 104, information regarding the interaction of the target recipients with offer is collected. This information can be communicated to the data segmentation engine to allow the data segmentation engine to segment and group the data based on the different interaction with the offer and the type of offer and information associated with the offer itself. The data segmentation engine also associates, or tags, information to each target recipient based on the interaction that each target recipient had with the given offer, as in act 106. In act 108, one or sematic graphs can be created, for example, by the graphing engine, to create a visual representation of the behavior of the target recipients to a given offer, including information about their behavior and the offers that elicit certain types of behavior. The graphs are displayed in act 110, for example, in a display 16 on the one or more data communication devices 12. In act 112, the target recipient list is updated based on the information gathered and segmented by the data segmentation engine. In act 114, a subsequent semantically-related offer is communicated to the updated target recipients list.

Any given engine or tool referred to herein or any functionality referred to herein may be implemented with one or more processing circuits. For example, a processing circuit, or a processing mechanism, may include both (at least a portion of) computer-readable media carrying functional encoded data and components of an active computer. The active computer is ready to execute (or is already executing) the functional encoded data, and thereby causes certain acts to occur. A processing circuit may also include: a machine or part of a machine that is specially configured to carry out a process, e.g., any process described herein; or a special purpose computer or a part of a special purpose computer. A processing circuit may also be in the form of a general purpose computer running a compiled, interpretable, or compilable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. Neither a processing circuit nor a process mechanism exists in the form of code per se, software per se, instructions per se, mental thoughts alone, or processes that are carried out manually by a person without any involvement of a machine.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus, comprising:
a data communications device configured to communicate one or more offers regarding a product or service to one or more target recipients, the target recipients viewing the offer on a display on a target recipient data communications device;
a data segmentation engine configured to communicate with the data communication device and to process data regarding the target recipients interaction with the one or more offers, the data segmentation engine being configured to tag the target recipients with data associated with the offer and with data regarding the target recipients interaction with the offer;
a graphing engine configured to create one or more semantic representations of behavior of the one or more target recipients, the semantic representations including information tagged to each target recipient by the data segmentation engine, the graphing engine being configured to present the one or more semantic representations on a display on the data communication device.

2. The apparatus of claim 1, wherein the data associated with the offer includes the type of product that the offer relates to.

3. The apparatus of claim 2, wherein the data segmentation engine utilizes metadata associated with the offer to determine the type of product.

4. The apparatus of claim 2, wherein data segmentation engine utilizes information from a product ontology to gather the data associated with the offer.

5. The apparatus of claim 1, wherein the interaction of the target recipients with the offer includes the target recipients viewing the offer.

6. The apparatus of claim 1, wherein the interaction of the target recipients with the offer includes the target recipients communicating the offer to additional target recipients.

7. The apparatus of claim 1, wherein the interaction of the target recipients with the offer includes the target recipients redeeming the offer.

8. The apparatus of claim 1, wherein the semantic representations are in the form of semantic graphs.

9. The apparatus of claim 1, wherein the semantic representations are used to determine one or more subsequent offers for communication to the target recipients.

10. Method, comprising:
segmenting a list of target recipients of an offer utilizing data associated with the offer and data regarding the interaction of the target recipients with the offer;
creating one or more semantic representations of the interaction of the target recipients, the semantic representations including information regarding the type of offers and the interaction of the target recipient with the offer; and;
presenting the one or more semantic representations on a display on a data communications device.

11. The method of claim 10, further including tagging the target recipients with the data associated with the offer and data regarding the interaction of the target recipients with the offer.

12. The method of claim 11, wherein the one or more semantic representations are creating using the tags associated with each target recipient.

13. The method of claim 10, wherein the semantic representations are in the form of semantic graphs.

14. The method of claim 10, further comprising determining a subsequent offer for communication to the target recipients based on the semantic representations.

15. Non-transitory computer-readable media encoded with data, the encoded data interoperable with a machine to cause:
segmenting a list of target recipients of an offer utilizing data associated with the offer and data regarding the interaction of the target recipients with the offer;
creating one or more semantic representations of the interaction of the target recipients, the semantic representations including information regarding the type of offers and the interaction of the target recipient with the offer; and;
presenting the one or more semantic representations on a display on a data communications device.
